(19) United States
(12) Patent Application Publication
(10) Pub. No.: US 2008/0244042 A1
(43) Pub. Date: Oct. 2, 2008

(54) Method and system for communicating media over a computer network

(76) Inventors: Sugih Jamin, Ann Arbor, MI (US); Wenjie Wang, Ann Arbor, MI (US); Zhiheng Wang, Fremont, CA (US); Hyunseok Chang, Astoria, NY (US)

Correspondence Address: BROOKS KUSHMAN P.C., 1000 TOWN CENTER, TWENTY-SECOND FLOOR, SOUTHFIELD, MI, 48075, US

(21) Appl. No.: 11/728,410

(22) Filed: Mar. 26, 2007

(51) Int. Cl. G06F 15/177

(52) U.S. Cl. 709/220

(57) ABSTRACT

Media is partitioned into k recurring frames or packets. Recurring frames of the same position 1 to k collectively define k media substreams which may be communicated from sending computers to a receiving computer over a computer network pursuant to a substream mask. The substream mask is defined by the receiving computer. Received substreams may be communicated to subsequent computers, and/or buffered for reassembly and playback at the receiving computer. Network node lists for substream and packet mask negotiation may be communicated to the receiving computer by sending computers or a rendezvous host.

### SUMMARY OF THE INVENTION

An object of this invention is to provide a novel technique and implementation for communicating media to a plurality of computers in a computer network. Other objects and advantages of the invention are manifested in the following description and the accompanying figures and claims.

One embodiment of the present invention includes partitioning media into k recurring frames or packets. Recurring frame positions collectively define k media substreams which may be communicated to parent computers over a computer network, such as a peer-to-peer or client-server network. At a child computer, substream masks may be defined for two or more of the parent computers. The substream masks define the substream(s) that the respective parent computer will communicate to the child computer over the computer network. The substream masks are communicated to the respective parent computers over the computer network. The substreams are received at the child computer from the two or more parent computers as defined by the substream masks.

The substreams may be buffered for reassembly and playback at the child computer. The child computer may alternatively or additionally become a new parent computer for communicating one or more of the substreams to a new child computer. Substreams may be transcoded before they are communicated to a new child computer.

According to another embodiment of the invention, the child computer may receive a list of potential parent computers for communicating one or more of the media substreams to the child computer. A rendezvous computer may be implemented to maintain a list of computers in the computer network. The rendezvous computer may receive requests for listings of computers in the network, enabling new nodes to find existing nodes in the network.

Another embodiment of the invention enables renegotiation of substream mask with parent computers in the event an existing substream falls below a predefined quality threshold. Media player buffer feedback may be a factor in determining whether a substream has fallen below a predefined quality threshold. The quality threshold may include an ID of a frame that has been sent to a playback module, and/or an ID of a frame that has been played by a playback module.

Another embodiment of the present invention is a playback computer which receives from two or more potential parent computers an identification of one or more media substreams that the potential parent computers are capable of communicating to the playback computer. The substreams comprise recurring frames of partitioned media. A message is sent to two or more of the potential parent computers defining substreams of the media to be communicated to the playback computer. Different parent computers may communicate different substreams to the playback computer. The substreams are received from the two or more potential parent peers according to their respective substream masks, and are assembled for playback.

Additional aspects and embodiments of the present invention are described in the following written description, illustrated in the accompanying figures, and recited in the claims.

### BRIEF DESCRIPTION OF THE DRAWINGS

FIG. 1 illustrates an example system topology according to one embodiment of the present invention;

FIG. 2 is a block flow diagram illustrating an example process overview of an embodiment of the present invention;

FIG. 3 is a block flow diagram illustrating an example of peer set negotiation;

FIG. 4 conceptually illustrates an embodiment for receiving at a media content playback module a plurality of media substreams from parent peer computers;

FIG. 5 conceptually illustrates an example input-output buffer for receiving and reassembling substreams; and

FIG. 6 conceptually illustrates an example ordering of substreams and recurring frames in an input-output buffer.

### DETAILED DESCRIPTION OF THE PREFERRED EMBODIMENT(S)

This detailed description and the accompanying figures are provided to illustrate example embodiments of the present invention. The embodiments are not intended to limit the scope of the appended claims. The topology and block flow diagrams presented and described herein provide certain configurations, steps and/or functions. Those of skill in the art will appreciate that all such configurations, steps and/or functions may not be necessary for implementing embodiments of the present invention, including those recited in the claims. Those of skill in the art will also recognize that embodiments of the present invention may be implemented in ways other than those specifically illustrated and described.

Embodiments of the present invention operate over a computer network, such as the Internet. Embodiments of the present invention may operate over other computer networks, such as local area networks, wide area networks, intranets, wireless networks, or hybrid networks comprising a combination of different network types. Embodiments of the present invention are not limited to a particular network type or configuration.

Embodiments of the present invention operate to stream media over a computer network. The media may include audio media, such as music or other audible content, video media, such as movies, live broadcast, recorded clips, or television programming content. Embodiments of the present invention are not limited to a particular media or media format.

The term “computer” may take various forms, including but not limited to a server, a personal computer, a laptop computer, a mobile computing device such as a cellular telephone, and a personal data assistant. The computer descriptions provided herein are for purposes of illustration, and are not to limit the types of computers that may be employed to perform the described function(s) and/or alternative functions.

### Topology and Function Overview

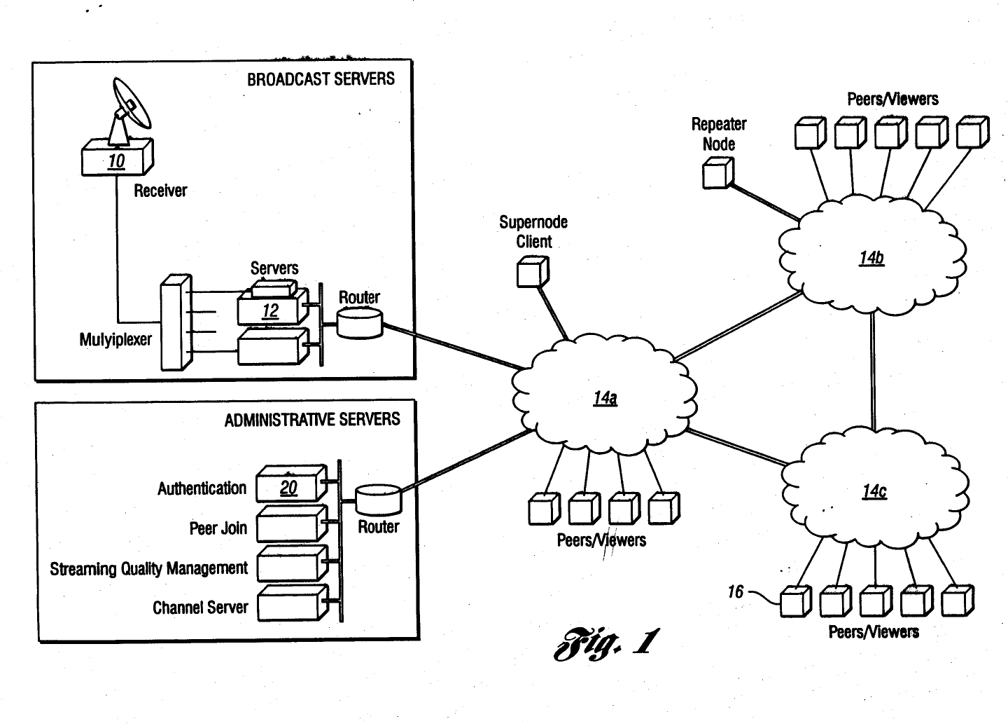

FIG. 1 illustrates an example topology according to one embodiment of the present invention. A receiver 10 may receive media content (e.g., audio, video, data, files, software, etc.) from a media source, and provide the media to a media server(s) 12. In an alternative configuration, the receiver 10 and the server(s) 12 are combined. In yet another alternative configuration, media server(s) include media.

In one embodiment of the present invention, media is partitioned into recurring frames. Each of the recurring frames collectively defines a substream. For example, as illustrated in FIG. 6, substream “A” comprises recurring media frames numbered 1, collectively. Substream “B” comprises recurring media frames numbered 2, collectively. Substream “M” comprises recurring media frames numbered 13, collectively. Of course, the particular number of substreams and the particular number of frames depends on the particular implementation of the present invention.

Media frames may be communicated via data packets. In one embodiment, one packet includes an entire frame. In other embodiments, a packet may include only a portion of a frame, or a single packet may include multiple frames. The best configuration may depend on the particular implementation of the present invention.

As described in greater detail below, the media substreams may be distributed to computers, directly or indirectly via intermediate computers, over computer network 14. In one embodiment, computer network 14 is a peer-to-peer network.

The term “peer-to-peer network” does not require a pure peer-to-peer network. The term does not exclude peer computers that may also be configured in a client-server or other non-peer arrangement. For example, the media server 12 illustrated in FIG. 1 is a “server” which serves media to, and is a part of, the peer-to-peer network 14. Similarly, “client” peer 16 which directly or indirectly receives the media originating from media server 12, and which may or may not serve media to any other peer, is nonetheless a part of the peer-to-peer network 14.

Peer 16 is representative of one or more peer computers in the network 14. Peer 16 may receive all or portions of the media directly from media server 12 or indirectly through other peers in the network 14. Peer 16 may play back the media through an appropriate viewer or player, which will depend at least in part on the type or format of the media. Additionally or alternatively, peer 16 will serve all or portions of the media to one or more other peer(s) in the network 14. The peer 16 may modify the media by transcoding it from one encoding to another, for example for video from MPEG4/H.264 to MPEG2 or to Windows Media Video (WMV), or by otherwise changing the information content of the encoded media, before serving the modified content to one or more peer(s) in the network 14.

Embodiments of the present invention may include one or more administrative servers. Other computing devices for administrative data processing and management may also be implemented. In an alternative configuration, the administrative devices may be combined, or the administrative functions described herein may be implemented by media server 12 or one or more other computers, including peers, connected to network 14. Authentication server(s) 20 may undertake authentication of peer 16 (and/or one or more or all other peers in network 14), as described in greater detail below. Peer join or rendezvous server(s) 22 may maintain and negotiate peer sets and/or subsets from which peer 16 may receive media in network 14, as described in greater detail below. Streaming quality measurement server(s) 24 may be implemented for estimating streaming capacity, loss rate, and other streaming quality measures for peers, such as when they are joining network 14 as described in greater detail below.

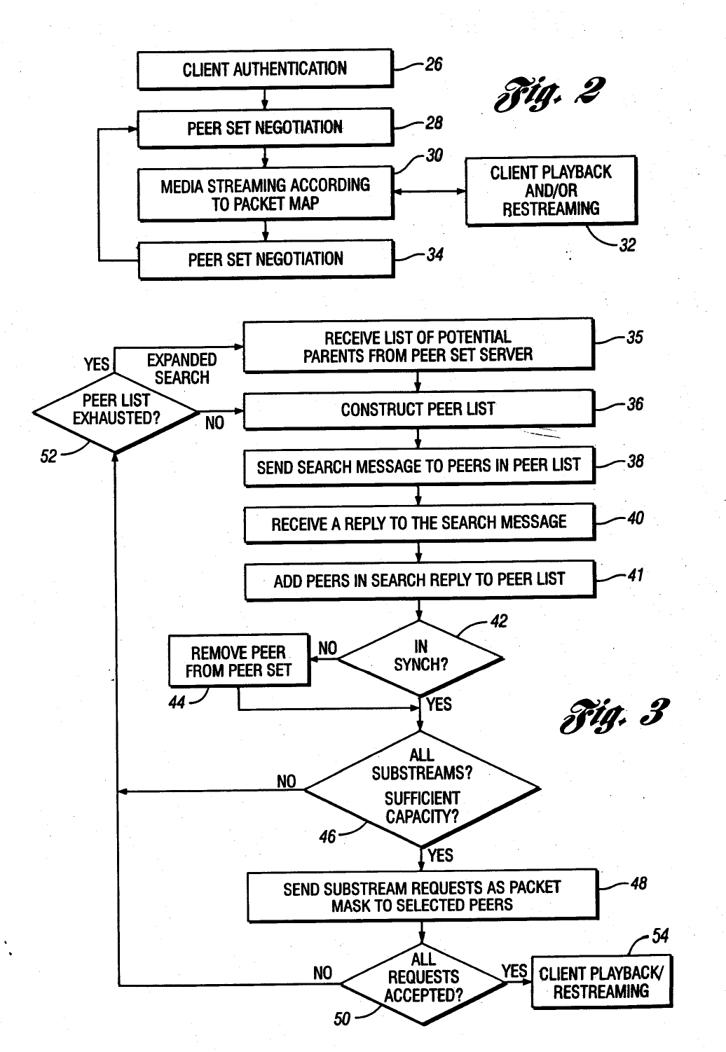

FIG. 2 is a block flow diagram illustrating an example process overview of an embodiment of the present invention, comprising client authentication 26, peer set negotiation 28, media streaming 30, client playback 32 and quality maintenance 34. Each of these aspects is described in greater detail below. Authentication 26, peer set negotiation 28 and/or quality maintenance 32 may repeat or take place continuously as peer sets are negotiated and while media is being streamed for client playback 30 among the computer network 14.

### Authentication

In one embodiment, peer authentication may take place each time a media player is run. In an alternative embodiment, peer authentication may take place at predefined, regular or random intervals. Authentication may also take place upon entering a pjoin state, or upon losing a parent peer, both of which are described in greater detail below.

A variety of methods for peer authentication may be implemented, such as public/private key encryption. Peers may be individually authenticated or centrally authenticated by authentication server(s) 20. An example centralized authentication technique similar to the KERBEROS network authentication protocol available from the Massachusetts Institute of Technology is provided. Those of skill in the art will recognize, however, that other techniques using other authentication protocols may also be implemented. For example, user authentication may be performed in conjunction with a third-party single-sign-on service such as SHIBBOLETH, COSIGN, FACEBOOK, YAHOO MAIL, AIM, etc.

Peer 16 may send information such as a userID, an IP address, and public key to authentication server 20. The authentication server 20 may challenge peer 16 to ensure that it indeed has the user's password and the matching private key. The authentication server 20 may then issue limited lifetime ticket(s) to the peer.

Peer 16 may then present the ticket to the peer set server 22. Peer set server 22 may challenge peer 16 to ensure that it indeed has the user's password and its matching private key. Peer set server 22 may verify ticket validity and provide peer 16 with a set of potential parent peers, as described in greater detail below.

Next, peer 16 may present the ticket to potential parent peers in the parent peer set received from peer set server 22. The parents may challenge peer 16 to ensure that it indeed has the user's password and its matching private key. The parents may verify ticket validity and provide peer 16 with a session key. The parent peer may send a channel license to child peer 16 using the session key. The channel license may contain a content key, which may be used by media content server 12 to encrypt the media content.

Finally, child peer 16 may receive a media license from the negotiated parent peer(s). The child peer media player may decrypt the media content using the content key in the license. The media content server 12 may generate new content keys periodically and propagate them down the distribution channel. In an alternate embodiment, each peer may obtain the channel license from one or more specialized license server, which may be provided by a third party.

Peer authentication may be used to control media distribution. In one embodiment, distribution volumes may be limited by geographic region using peer IP address. In an alternate embodiment, concurrent unique IP addresses may be used to limit the number of concurrent licenses granted. In yet another embodiment, media distribution may be controlled by both IP address and the number of concurrent unique IP addresses.

### Peer Set Negotiation

In one embodiment of the present invention, the peer set or rendezvous server 22 maintains a list including existing peers in network 14, and provides a service for a new peer 16 to obtain a list comprising a subset of those existing peers as potential parent peers to serve media to the new peer 16 originating directly or indirectly from the media content server(s) 12. In an alternative embodiment, media originates from one or more individual peer computers, and not a central media server 12.

The peer list may be randomly created, and may include N members. An exception to the randomly created peer set list may be a reference to the root node, or media server 12. In another embodiment, the list of existing peers may indicate some peers as having higher peering preference or performance. For example the media server 12 and/or other well provisioned peers (supernodes) may be so indicated. These supernodes may be deliberately placed on the network. The indication may be in the form of listing the higher preference peers first.

FIG. 3 is a block flow diagram illustrating an embodiment of peer set negotiation. Those of skill in the art will recognize that the steps illustrated in FIG. 3 and described herein may be rearranged, modified, supplemented or omitted to suit a particular implementation of the present invention.

Once a new peer 16 obtains a list of parents from the peer set server 22, as represented in block 35, the new peer may enter a peer join or “pjoin” state. The pjoin state may include one or more of the following steps, which need not occur in the order provided, and which may occur serially or in parallel.

1. Construct a pjoin peer list. A pjoin peer list may be constructed to list potential parent peers, as represented by block 36. The pjoin peer list may be populated by selecting, randomly or otherwise, a subset of the peers listed in the set received from the peer set or rendezvous server 22.

2. Search. A search message may be sent to the potential parent peers in the pjoin peer list, as represented in block 38. A potential parent that receives the search message may reply with a search reply message, as represented in block 40. The search reply message may include one or more items of information, such as the media substream(s) it has capacity to serve (described below), a frame ID array which identifies the latest frame IDs that the peer has for each substream (described below), and/or information indicating whether or not the peer has the capacity to accept and deliver one or more substream(s) to the new child peer 16. Search messages may be sent in a batch to multiple potential parents or serially. The search message may be used to discover other peers. When a potential parent replies to the search message, it may attach a list of its other peers in its search reply message as illustrated in block 41.

3. Out-of-sync peer elimination. Potential parent peers that are out-of-sync for streaming the media sought may be eliminated from the set of potential peers, as represented in blocks 42 and 44. According to one embodiment, the new peer may compare the frame IDs received from potential parent peers to determine which of the potential parent peers, if any, are too far out of frame synchronization to be a suitable parent peer.

4. Join. When a sufficient number of search reply messages have been received, the new peer 16 may attempt to join the network 14, as represented in block 46. A sufficient number of search reply messages may be determined by the bandwidth requirement of the stream and the bandwidth capacity of each peer. For example, it may be assumed that a video stream is sent at 400 kbps, and that each peer can only provide 100 kbps, requiring reply messages from four peers. The new peer may send a join query message to the potential parents, as represented in block 48. The join query message may contain a list of service substreams the peer is requesting from the parent. This list of service substreams may be among those substreams the parent is/was capable of serving as indicated in the search reply message. This list of service substreams may be used to create a substream or packet mask. The substream mask may limit service of packets to one or more of those substreams that are among the service substream list. Potential parent peers may also reply with a join reply message, indicating success or failure to accept the new peer 16 as a child, as represented in block 50. The join reply message may include information about which substreams it is serving the child, which may be a subset of the substreams the new peer 16 requested. At this point, a content link may be established between the parent peer(s) and the new peer 16. The content link may be a virtual link, one embodiment of which may comprise of a source-recipient association. Once the content link is established, the parent may begin sending the negotiated media substreams to the peer for playback and/or streaming to other peers, as represented in block 54. Additional join reply messages may continue to be received from other potential parent peers over time. When a peer receives those messages, it may choose to adjust the substreams received from the current parents to prevent duplicate substreams from being sent by multiple parents, or to enhance service quality. Substream mask adjustment may be performed by sending a substream mask update message to a parent.

5. Expanded search. This step may be executed if the join step did not result in a sufficient number of available parents from the peer list for the new peer 16, as represented in block 52. Expanded search may also be triggered by the Quality Maintenance procedure discussed later. Criteria such as elapsed time or maximum number of connection attempts may delineate when, or at what point, the expanded search step is entered into. The pjoin peer list may be expanded by adding more potential parents identified by the peer set server or those attached to search reply messages, and the search-join steps may be repeated for one or more new potential parents. The expanded search may repeat until a suitable set of parent peers is negotiated. Alternatively, the expanded search may repeat until maximum number of attempts or a threshold timeout period has expired.

### Input-Output Buffer System

As explained above, audio, video or other media content may be distributed via substreams to a child peer in a fashion that allows the child peer to have more than one distributing parent. In one embodiment, the media content may be served among M substreams. A parent may serve any number of those M sub-streams independently to one or more children. A child may receive different substreams from different parents, and may reassemble those substreams into the full content stream for playback.

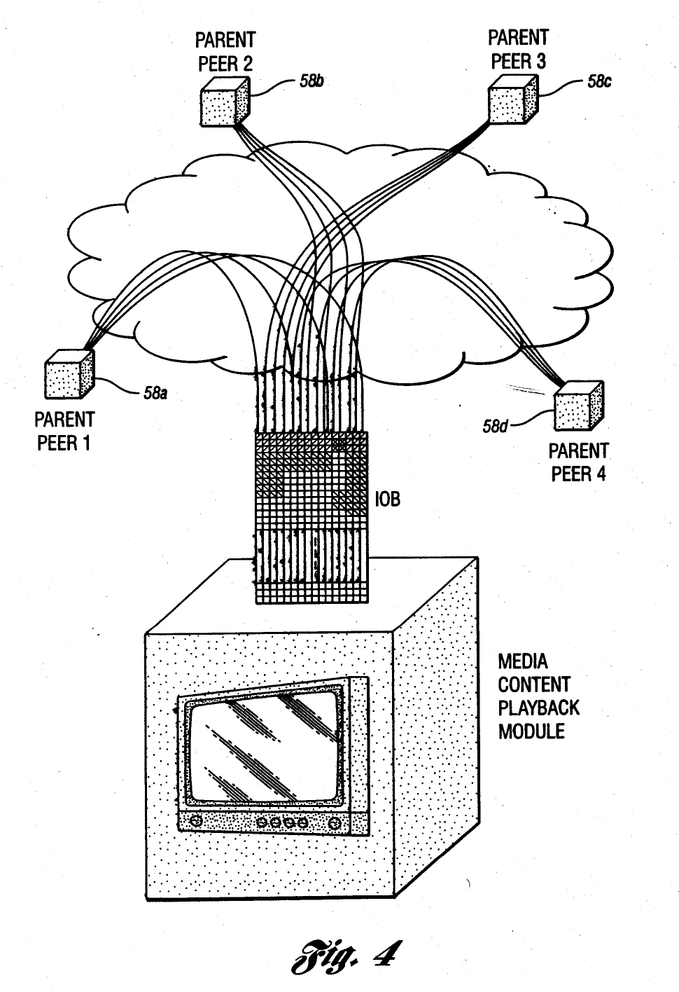

FIG. 4 graphically illustrates the receipt at a media content playback module 56 of M substreams from four parent peers 58a-58d. As described in greater detail below, the M substreams are assembled in an Input-Output Buffer (“IOB”) 60 associated with the media content playback module 56.

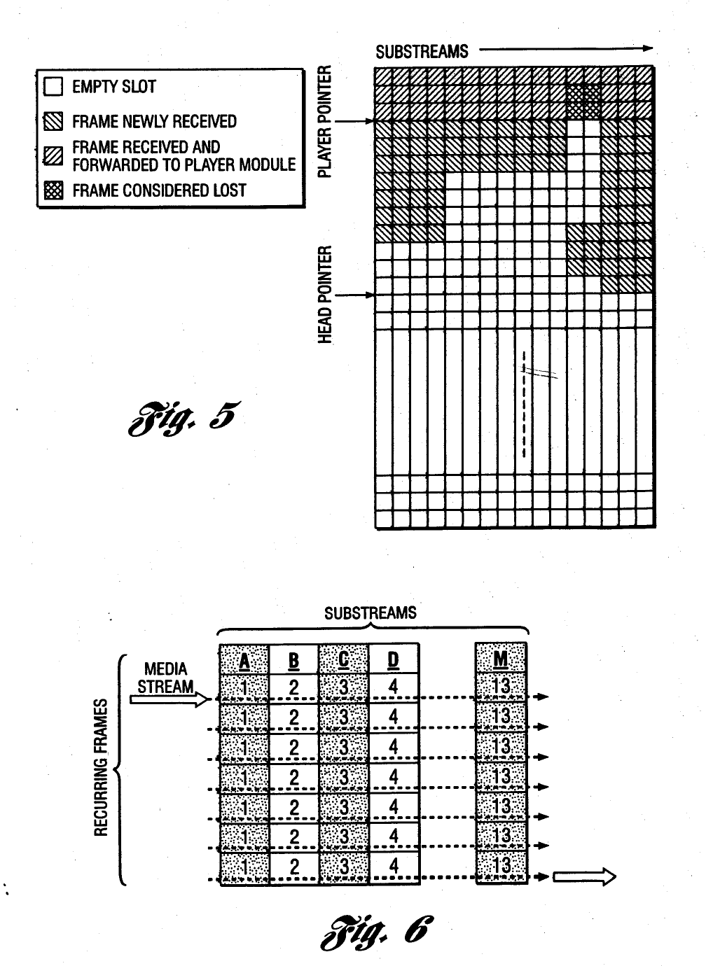

FIG. 5 conceptually illustrates an example input-output buffer or “IOB”. The IOB may be conceptually structured as a number of rows, each of which corresponds to a series of data frames. A row in the IOB may be referred to as a segment. The segments may be numbered in increasing order, where larger numbered segments include data packets later in the media stream.

Each row/segment of the IOB may be divided into M columns, each corresponding to a substream. Each column in a segment may be referred to as a frame. The frames may be numbered in increasing order. As substream frames are received from parents 58a-58d, they are assembled in the IOB 60. The IOB 60 may cache assembled frames until they are ready to be delivered to the player module 56. In an alternate embodiment, the IOB 60 may send all frames to the player module as soon as they arrive.

A player pointer refers to the number of the latest frame that was sent to the player module 56. The segment containing the latest frame that is sent to the player module may not have all of its frames present in the case where substream frames do not arrive on time for delivery or when delivery is not contingent upon receiving all substream frames. A head pointer refers to the number of the latest frame received.

An alternative implementation may include the use of two IOBs in coordination with one another (not shown). When the head pointer advances beyond the bottom of one IOB, the other IOB is emptied, and the top frame number is set to one greater than the previous IOB's bottom frame number. The head pointer may then move into the newly initialized IOB as additional substream packets arrive. This may be referred to as an IOB switch event.

In one embodiment, the player pointer may advance when a complete segment is assembled (all M substream frames received) in the slot just below the player pointer. The player pointer may be advanced to the last complete segment sequentially available from its current position, and the data from the complete segment may be sent to the player module 60. In another embodiment, the player pointer may be advanced frame by frame. In yet another embodiment, IOB-player interaction may be configured to allow for out-of-order frame delivery, whereby frames are sent to the player module as soon as they arrive, even if they arrive out of order; the player may maintain a buffer to reassemble the arriving frames into their original order. The original order of the frames may be determined from the ID of the frames or the playback timestamps of the frames. A frame whose arrival is later than its playback timestamp may be skipped for playback by the player. If the available frames in the buffer is below a threshold, the player may slow down play back to allow for more data to be buffered. In one embodiment, the player may also notify the IOB of its level of playback buffer occupancy.

According to one embodiment, the player pointer is not permitted to be more than a threshold number of frames behind the head pointer. This threshold may be referred to as a wait threshold. If the head pointer advances beyond the wait threshold, the player pointer may be forced to move ahead just enough to stay within the threshold. The frames between the old and new positions may be sent to the player module, even if some or all substream frames are missing. In another embodiment, reaching the wait threshold may cause the IOB to measure the loss rate or the ratio of out-of-order frames between the player pointer and the head pointer.

The wait threshold value may be assigned dynamically if player buffer feedback is available, or statically assigned otherwise. When player buffer feedback is available, the wait threshold may be initialized to a sufficiently large number to enable the player pointer to wait. The wait threshold may be adjusted when the player buffer drops below a predefined low level. The wait threshold may be reduced to a smaller number, which in one embodiment may force frames to be flushed to the player, even if they are incomplete.

The wait threshold may also be adjusted when the player buffer increases above the low level. The wait threshold may be set to a larger value to allow the IOB more time to wait for late frames.

### Client Playback And/Or Re-Streaming

When the new peer has obtained a set of parents serving the full set of substreams for the media, it may begin transmission of the full stream to the content playback module 56 and/or re-streaming to other peers 16. The playback module 56 may be a platform specific component that interfaces between platform specific code and a network daemon code. For audio/video broadcasts, for example, this aspect may be implemented through the use of the FFMPEG code libraries and a network daemon library.

For non-playback related functions, such as logging in, joining a channel, quitting a channel, getting current status while connecting to a channel, checking for errors experienced by the daemon, etc., the user interface may call methods in the network daemon library, which in turn may send these messages to the daemon itself. With this arrangement the user interface may be decoupled from the networking code, providing a cross platform network daemon, and a platform specific user interface.

Several operating system platforms may be supported, such as MICROSOFT WINDOWS, MACINTOSH OS X, and LINUX. In one embodiment, the WINDOWS player may be implemented with C#.NET, and the MACINTOSH OS X player may be implemented using ObjectiveC and Cocoa. Of course other languages, coding and playback architectures may be implemented. For decoding video, FFMPEG may be used. A network daemon library may interface with the FFMPEG code for basic media player functionality, such as playing a stream file, changing volume, stopping a stream file, resizing the video, and getting the native resolution of the stream. Video may be drawn using a platform specific graphics library (e.g., OPENGL on MACINTOSH, DIRECT-X on WINDOWS, etc.). This may also permit use and implementation of different or new codec releases. For example, to use QUICKTIME instead of FFMPEG, the QUICKTIME libraries could be used to handle the basic player functionality described above, and the user interface could implement the QUICKTIME libraries instead of FFMPEG. In this manner, any media player could be implemented so long as the appropriate libraries are available.

The media player may be equipped with player buffer feedback. The status of the input buffer in the media playback module may be periodically or continuously reported to the IOB network module. For example, the amount of playback time of the remaining data in the buffer (player buffer level) may be communicated from the media player module to the IOB networking module. For another example, the frame ID that is ready for playback may be communicated to the IOB networking module. In one implementation, the playback buffer may buffer X seconds of content before the content is presented to the user. The playback buffer is drained as content is played back to the user, and filled at the same time as data is received from the IOB. If the remaining data in the playback buffer is low, the content player may slow down playback in order for data to catch up. If the IOB is completely drained, the player may stall playback until there is enough data in the playback buffer to resume smooth playback. Should the IOB happen to increase in size rapidly, the playback of content may speed up to deplete buffered data until the buffer size returns to a smaller size (e.g., 2X seconds).

The playback buffer may have certain status thresholds. For example, a low status threshold indicates that the amount of data left is running low. A critical status threshold indicates that the amount of data left is very low and measures may be taken to replenish the buffer.

### Quality Maintenance

Streaming quality measurement server(s) 24 and/or peers 16 may monitor the state of peer-parent content links to maintain substream quality and synchronization based on predefined quality thresholds including but not limited to those described herein. A lossy parent peer may be a parent from which a child peer experiences frame or packet loss in one or more substreams transmitted by that parent peer. Scattered or lost packets may be an indication of poor network connectivity between a parent and the child, perhaps over a lossy or congested connection.

According to one embodiment, lossy parent detection is carried upon an IOB switch event, as described above. However, a no-detection grace period may be implemented after the pjoin procedure completes. This may allow for initial network instabilities to be ignored.

During detection, one or more substreams may be inspected for lost packets. A packet may be considered lost if the packet containing an expected ID or timestamp does not arrive or arrive too late for playback. If a substream contains a greater number of lost packets than a specified threshold, then the parent supplying that stream may be considered lossy. Notably, a slow parent is technically not lossy, but may be treated as such. It is also possible that the parent-peer connection is acceptable but one or more of a parent's own parents is lossy. In one embodiment, it may be assumed that the immediate parent is at fault. In another embodiment, parents may send alternate packets in place of packets they did not receive, allowing the child peer to determine that the fault lies with a distant ancestor instead of the immediate parent.

When a parent is identified as lossy, the child peer may renegotiate the substream/packet mask be sending a substream or packet mask update request to the parent, requesting a reduction in the number of substreams the parent is supplying. The substreams to be dropped may be all substreams or a randomly chosen set; or the most lossy substreams may be discarded first. Additionally or alternately, packet mask update requests may be sent to other existing parents, if any, asking them to supply the discarded or lossy substreams. Lossy parents may be added to a list of known lossy parents. Known lossy parents may be removed from consideration in any join process for some period of time.

Packet loss may be the result of temporary network congestion. In that case, the loss of packets may be just a one-time event, not a persistent condition that would warrant replacing a parent peer. To deal with such temporary packet loss without having to adjust substreams, the child peer may request that the parent peer or other potential parent peers retransmit the lost packets. In one embodiment, the child peer may check the latest incoming substreams from each parent peer, and look for any packet loss associated with the parent peer. Upon detecting any loss of packet(s), the child peer may obtain from the pjoin query list a set of target peers to send the retransmission request to. Among those obtained peers, those which have spare capacity may be used as target peers. If there is not a sufficient number of eligible target peers, the list of target peers may be expanded by adding more peers identified by the peer join server(s) 22. Once a set of target peers is determined, a retransmission request for a batch of the identified lost packets may be sent to them. Target peers may or may not respond to the request depending on their current upstream capacity limit. If more than one target peer respond and send the requested packets, any duplicate incoming packet may be discarded.

If feedback from the peer's media player is available, the IOB may be more tolerant of delayed packets. When the media player buffer level is above the low threshold, a lossy parent may be asked to retransmit lost packets through a packet retransmission request. When the player buffer level is below the low threshold, lossy parent substreams may be renegotiated as described above. If the player buffer level is below the critical threshold, lossy parent substreams may be renegotiated, and lost packets may be skipped and the player pointer advanced.

A slow parent is one that transmits packets in one or more substreams which arrive at a child peer too late to be used for playback. In one embodiment, a packet may be considered late if its ID is smaller than the ID of the packets already sent to the playback module. In another embodiment, a packet may be considered late if its ID is smaller than the ID of the packets already played back by the playback module. The IOB may receive the late packets, but may decide not to send them to the playback module. Slow parents may be detected and handled in a manner similar to lossy parents. Late packets may be counted as lost packets.

As an example, a slow parent may be identified if the packet loss rate (percentage of packets missing between player pointer and the latest received packet for that parent) in the IOB for the parent's substreams is above a fixed threshold percentage, and the ID of the last packet received from the parent is smaller than the ID of the current packet sent to the playback module.

When the player buffer level is above the critical threshold, slow parent substreams may be renegotiated as described above. When the player buffer is below the critical threshold, slow parents may be removed and existing parents may be requested to cover the missing substreams. The join procedure may also be started to discover new parents if necessary.

A parent may disconnect from a child peer when it leaves the network, terminates the media channel, or when unfavorable network conditions cause the connection to be broken. When a parent has disconnected, the child peer may send substream or packet mask update requests to its existing parents to request that they cover the missing parent's substreams. If insufficient capacity is available from the existing parents or there are no other parents available, the peer will start the join procedure to discover new parents.

A peer may periodically query its ancestors, or a random subset thereof, to obtain a list of the ancestor's children. This operation expands the list of possible parents that the child peer has knowledge of. The peer may also choose to join a new parent from its list of candidates, if the number of parents the peer currently has is low.

A peer may also determine upstream capacity, the number of substreams a parent peer is able to supply to children without unacceptable data loss. Initial upstream capacity may be estimated by sending message(s) to a reliable bandwidth measurement server before a peer joins the network. Upstream capacity may be dynamically adjusted by evaluating feedback sent by child nodes. For example, if adding a new child causes all existing children to suddenly experience packet loss, the parent node's upstream capacity is likely to be overestimated; the new child may then be dropped and the parent's upstream capacity reduced. In another scenario, a parent peer's upstream connection may be temporarily congested by the use of other application(s) such as file uploading that share the same upstream bandwidth. Such temporary connection congestion may trigger a slow parent handling procedure on the child peer(s), and the parent peer may be asked to drop some of the substreams it has been serving to the child peer(s), and may reduce its upstream capacity accordingly. Alternatively, if a majority of children do not experience much loss for a long time, then upstream capacity may be increased until loss is reported, then scaled back to a safe margin.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for communicating media over a computer network, the method comprising:
partitioning media into k recurring frames wherein frames of recurring positions collectively define k media substreams;
communicating one or more of the media substreams to two or more parent computers over a computer network;
at a child computer, defining a substream mask for each of two or more of the parent computers, each substream mask defining the substream(s) that the respective parent computer will communicate to the child computer over the computer network;
communicating the substream masks to the respective parent computers over the computer network; and
at the child computer, receiving the substreams from the two or more parent computers as defined by the substream masks.

2. The method of claim 1 additionally comprising buffering the substreams for reassembly and playing the media on the child computer.

3. The method of claim 1 additionally comprising receiving at the child computer a list of potential parent computers for communicating to the child computer one or more of the media substreams.

4. The method of claim 1 wherein the child computer becomes a new parent computer for communicating one or more of the substreams to a new child computer.

5. The method of claim 4 additionally comprising transcoding the substreams before they are communicated to the new child computer.

6. The method of claim 1 wherein the computer network is a peer-to-peer network.

7. The method of claim 1 additionally comprising:
maintaining at a rendezvous computer a list of computers in the computer network;
submitting a request to the rendezvous computer for a list of potential parent computers;
receiving from the rendezvous computer the list of potential parent computers;
submitting a request to join the computer network to at least one of the potential parent computers on the list; and
receiving a response to the request to join the computer network, the response indicating whether the responding parent computer has capacity to communicate one or more of the substreams to the child computer.

8. The method of claim 7 additionally comprising:
if the child computer does not receive responses from a sufficient number of potential parent computers indicating that they have capacity to collectively communicate all of the media substreams, sending a request to the rendezvous computer for a supplemental list of potential parent computers, and submitting a request to join the computer network to at least one of the potential parent computers on the supplemental list until the child computer has received responses from a sufficient number of potential parent computers having capacity to collectively communicate all of the media substreams to the child computer.

9. The method of claim 1 additionally comprising:
receiving at the child computer a list of one or more peers of a parent computer; and
negotiating a substream mask with one or more peers of a parent computer.

10. The method of claim 1 additionally comprising authenticating the child computer.

11. The method of claim 1 additionally comprising renegotiating the substream mask with a parent computer in the event an existing substream falls below a predefined quality threshold.

12. The method of claim 11 wherein media player buffer feedback is a factor in determining whether a substream has fallen below a predefined quality threshold.

13. The method of claim 11 wherein the quality threshold includes an ID of a frame that has been sent to a playback module.

14. The method of claim 11 wherein the quality threshold includes an ID of a frame that has been played by a playback module.

15. The method of claim 1 wherein the frames are packets.

16. A playback computer having a capability to receive media communicated over a computer network for playback, the computer being programmed and configured to:
receive from two or more potential parent computers connected to the computer network an identification of one or more media substreams that the potential parent computers are capable of communicating to the playback computer, each substream comprising recurring frames of partitioned media;
send a message to two or more of the potential parent computers defining substreams of the media to be communicated to the playback computer such that different parent computers communicate different substreams to the playback computer;
receive substreams of the media from the two or more potential parent peers according to their respective substream masks; and
assemble the received substreams for playback.

17. The computer of claim 16 additionally programmed and configured to communicate one or more of the substreams to another playback computer.

18. The computer of claim 16 additionally programmed and configured to change a parent computer's substream mask in the event one or more of the parent computer's substreams fall below a predefined quality threshold.

19. The computer of claim 18 wherein the quality threshold includes an ID of a frame that has been sent to a playback module.

20. The computer of claim 18 wherein the quality threshold includes an ID of a frame that has been played by a playback module.

21. The computer of claim 18 wherein the message includes a substream or packet mask.

22. A playback computer for playing media received over a computer network, the playback computer comprising:
a means for identifying two or more parent computers in the computer network having capacity to communicate one or more media substreams to the playback computer, the substreams respectively comprising recurring frames of partitioned media;
a means for defining which substreams two or more of the parent computers will communicate to the playback computer; and
a means for assembling the substreams upon receipt at the playback computer.

23. The computer of claim 22 additionally comprising a means for buffering the substreams.

24. The computer of claim 22 additionally comprising a means for playing the assembled substreams.

25. The computer of claim 22 additionally comprising a means for redefining which substreams one or more parent computers will communicate to the playback computer in the event one or more of an existing parent computer's substreams fall below one or more quality thresholds.
